(19) United States
(12) Patent Application Publication
(10) Pub. No.: US 2011/0253859 A1
(43) Pub. Date: Oct. 20, 2011

(54) Fastening device for add-on components on mounting rails

(75) Inventors: Peter Ostermeier, Diessen (DE); Norbert Burtscher, Thueringen (AT); Hermann Fritz, Landsberg (DE)

(73) Assignee: Hilti Aktiengesellschaft, Schaan (LI)

(21) Appl. No.: 13/066,521

(22) Filed: Apr. 15, 2011

(30) Foreign Application Priority Data
Apr. 19, 2010 (DE) 10 2010 027 904.8

(51) Int. Cl. F16M 13/00

(52) U.S. Cl. 248/223.41

(57) ABSTRACT

Add-on components (3) are to be fastened to a support part (5) with a simple technical set-up and without a need for tools, with a device (1) for fastening an add-on component (3) to a support part (5), including at least one movable holding element (16) that, when it is inserted into an opening (10) of the support part (5) due to the contact between the at least one holding element (16) and the support part (5), can be moved into an engagement position so as to be inserted into the opening (10), and that, after it has been inserted into the opening (10), can be moved into a catching position by a return movement of the at least one holding element (16) so that the at least one holding element (16) can catch behind at least one edge (9) of the support part (5) in order to create a positive connection between the at least one holding element (16) and the support part (5), and at least one affixer for affixing the add-on component (3) to the device (1). At least one holding element (16) can be moved from the engagement position into the catching position by at least one elastic element (8).

This claims the benefit of German Patent Application DE 10 2010 027 904.8, filed Apr. 19, 2010 and hereby incorporated by reference herein.

The present invention relates to a device for fastening an add-on component to a support part, and to a system for fastening an add-on component to a support part.

### BACKGROUND

In structural engineering, devices for fastening an add-on component to a support part are employed in order to fasten add-on components to the support part. Examples of add-on components are photovoltaic modules, façade elements or lines as components of a water-heating system or of an electric installation. In general, support rails or mounting rails are employed as the support parts.

German Patent Application No. 103 13 564 A1 shows a connection element for components. The components are provided with slots that are aligned with each other for purposes of receiving the connection element, whereby the connection element is configured as a one-piece spring clip that has diametrically projecting spring arms whose width is dimensioned so they can be inserted into the slots, whereby a bearing section is at an axial distance opposite from the free ends of the spring arms, said bearing section being shaped onto the spring clip and having an engagement section for a mounting tool.

German Patent Application No. 10 2006 011 836 B3 discloses a fastening element having a baseplate. Opposing first arms, which each have a first contact section, project from the baseplate at a first distance from the baseplate, and at least two opposing second arms, which have a second contact section, also project from the baseplate at a second distance from the baseplate. Here, the first arms have actuation sections that are each configured as a surface with an eyelet.

German Patent Application No. 10 2007 042 484 B3 discloses a device for fastening an add-on component to a support part, having a head part that has contact sections projecting laterally and that is intended for contact with the add-on component or with the support part. An elastic front wall arrangement has two barrier flaps that are oriented approximately at a right angle relative to the front wall. These barrier flaps have latching steps that rest on the support part when the device is in a catching position.

German Utility Model No. 20 2005 003 224 U1 discloses an insertion part for holding a sliding block in an undercut profile groove of a profile strip. In its inserted state, the insertion part has the same essentially parallel longitudinal axis as the axis of the profile strip, whereby the insertion part has a seat for the sliding block with axially opposite seat-limiting surfaces between which the sliding block can be held, as well as bearing surfaces that are arranged between the seat-limiting surfaces in order to bear the sliding block. In this context, the insertion part has first support surfaces which, when the insertion part is in the inserted state, provide support of the said insertion part on undercut surfaces of the profile groove, whereby at least some of the first support surfaces are arranged so as to be flexibly deflectable in such a way that the insertion part can be inserted into the profile groove through the opening of the profile groove.

German Utility Model No. 20 2006 018 426 U1 discloses a mounting rail system for holding objects, especially flat elements such as solar modules or solar collectors, whereby at least one rail-like profile having at least two profile strips running in the longitudinal direction of the rail-like profile and at least one resiliently elastic clamping element for fastening the rail-like profile to a substrate and/or for holding objects on the rail-like profile having at least two spring legs that engage with opposite sides of the rail-like profile and that are opposite from each other interact with one of the profile strips in such a way that the resilient clamping element can be resiliently affixed to the rail-like profile.

### SUMMARY OF THE INVENTION

It is an object of the present invention to provide a device and a system with which add-on components can be fastened to a support part by means of the device and by means of the system employing a simple technical set-up and without a need for tools. Furthermore, the device and the system should be cost-effective to produce and should allow simple and reliable handling.

The present invention provides a device for fastening an add-on component to a support part, comprising at least one movable holding element that can preferably be pivoted around a rotational axis and that, when it is inserted into an opening of the support part due to the contact between the at least one holding element and the support part, can be moved into an engagement position so as to be inserted into the opening, and that, after it has been inserted into the opening, can be moved into a catching position by means of a return movement of the at least one holding element, so that the at least one holding element can catch behind at least one edge of the support part in order to create a positive connection between the at least one holding element and the support part, and comprising at least one means for affixing the add-on component to the device, whereby the at least one holding element can be moved from the engagement position into the catching position by means of at least one elastic element, and/or can be moved in a clamping movement.

In another embodiment, the at least one holding element and the at least one elastic element are separate parts. The at least one holding element and the at least one elastic element are thus separate parts that are preferably detachably connected to each other. Only when the device is being installed is the at least one holding element joined to the at least one elastic element, for example, positively and/or non-positively.

In one variant, the device comprises at least two holding elements, and/or, when the at least one holding element is in the catching position, it is arranged at least partially, especially completely, in a hollow space enclosed by the support part, and/or two holding elements are arranged opposite from each other, and/or a non-positive connection can be established between the at least one holding element and the support part.

In another embodiment, the at least one means encompasses a carrier plate or a grid for purposes of affixing the device to the add-on component, preferably directly.

In a supplementary variant, the at least one holding element is a chuck which preferably can be pivoted around a rotational axis.

Advantageously, the device may comprise a web that can be inserted into the opening and the at least one holding element is pivotably mounted on the web, preferably by means of an articulated joint.

In a supplementary embodiment, the web is formed, preferably in one piece, on the carrier plate, and/or a plane formed by the web is arranged essentially perpendicular, for instance, with a deviation of less than 10° or 5°, with respect to a plane formed by the carrier plate.

In particular, a contact surface of the at least one holding element on the support part may be configured so as to be curved, essentially as a contact-surface arc, especially in a section perpendicular to the rotational axis of the at least one holding element.

In another embodiment, the at least one edge of the support part that can be caught by the at least one support part is curved, especially in a section perpendicular to the rotational axis of the at least one holding element, essentially as an edge arc.

In a supplementary embodiment, the center point of the contact-surface arc and/or the center point of the edge arc and/or the rotational axis of the at least one holding element are oriented with respect to each other in such a way that, when the at least one holding element executes a clamping movement, the distance between the edge of the support part and the contact surface of the at least one holding element is reduced, and/or the at least one elastic element is configured as a spring, especially as a wire spring. The clamping movement is preferably a movement of the at least one holding element in the direction of a pre-mounted position into the engagement position or in the direction of the return movement.

In another embodiment, the support part and/or the device and/or the carrier plate and/or the web and/or the at least one holding element and/or the at least one elastic element is made at least partially, especially completely, of metal, for instance, aluminum, steel or stainless steel, and/or it is made of plastic.

In a supplementary embodiment, there is a positive and/or non-positive connection between the device and the support part, and/or there is a clamping connection and/or a connection with a wedge effect or eccentric effect between the support part and the device.

In another embodiment, the device can be fastened to the support part by means of a snap mechanism and/or latching mechanism.

In a supplementary embodiment, the at least one movable holding element is not pre-tensioned when it is in the pre-mounted position. The at least one movable holding element is in the pre-mounted position when the device is not mounted on the support part and the at least one holding element is not in the engagement position and/or in the catching position.

Preferably, the at least one holding element is configured to be essentially, especially exclusively, plate-like or disk-like. The at least one holding element can thus be produced easily and cost-effectively, and it makes a reliable positive connection between the device and the support part possible.

In another embodiment, the at least one means comprises an adhesive, latching, riveted and/or screwed connection for purposes of affixing the add-on component to the device, especially to the carrier plate.

In another embodiment, the at least one elastic holding element has essentially no elastic properties and/or the at least one holding element is rigid and/or hard and/or essentially undeformable, for example, owing to the properties of the material of which it is made, and/or owing to the material thickness.

A system according to the invention for fastening an add-on component to a support part, comprising a device for fastening the add-on component to the support part, comprising at least one holding element that can be inserted into an opening of the support part and that can catch behind at least one edge of the support part with at least one movable holding element that, when it is inserted into the opening due to the contact between the at least one holding element and the support part, can be moved into an engagement position so as to be inserted into the opening, and that, after it has been inserted into the opening, can be moved into a catching position by means of a return movement of the at least one holding element, so that the at least one holding element can catch behind the at least one edge of the support part in order to create a positive connection between the at least one holding element and the support part, and also comprising at least one means for affixing the add-on component to the device, and also comprising the support part, whereby the device is configured as a device described in this patent application.

In another embodiment, the support part is a support rail, and/or the opening is a groove and/or the opening opens up into a hollow space delimited by the inside contour of the support part, so that the at least one edge is formed by the inner contour of the support part so that it can catch behind the at least one holding element.

In a supplementary embodiment, the opening is a mounting opening for fastening the device to the support part.

In a supplementary variant, when the device is fastened to the support part, two opposing holding elements are oriented with respect to a plane that runs through a central longitudinal axis of the support rail in such a way that the plane runs through the two holding elements and the plane is divided by the central longitudinal axis of the rail into a first partial plane and a second partial plane, and a first holding element is intersected by the first partial plane while the second holding element is intersected by the second partial plane. The central longitudinal axis of the rail is oriented in the direction of the greatest extension of the support rail and it preferably intersects the center point or the center of gravity of the support rail. The longitudinal axis of the rail can also be moved in parallel, so that it does not intersect the center of gravity.

In another variant, before the holding elements are inserted into the opening, the distance between the ends of two opposite holding elements in the direction of the distance is greater than the clear width of the opening in the direction of the distance, so that, when the two opposite holding elements are inserted, the holding elements can be moved due to the contact with the support part, especially in such a way that the maximum distance is reduced.

In another embodiment, when the device is fastened to the support part, the elastic element is pre-tensioned and consequently a pre-tensioning force can be exerted onto the at least one holding element, so that a clamping movement can be executed by the at least one holding element due to the pre-tensioning.

### BRIEF DESCRIPTION OF THE DRAWINGS

Embodiments of the invention will be described in greater detail below with reference to the accompanying drawings. The following is shown:

FIG. 1: a first perspective view of a system for fastening an add-on component to a support part and of a device;

FIG. 2: a cross section of the system according to FIG. 1, in the pre-mounted state;

FIG. 3: a cross section of the system according to FIG. 1, in the final mounted state;

FIG. 4: a cross section of a carrier plate with a web and two holding elements of the system according to FIG. 1;

FIG. 5: a perspective view of a wire spring, in a first embodiment;

FIG. 6: a perspective view of the wire spring, in a second embodiment;

FIG. 7: a detailed view of the support part and of the device according to FIG. 3.

### DETAILED DESCRIPTION

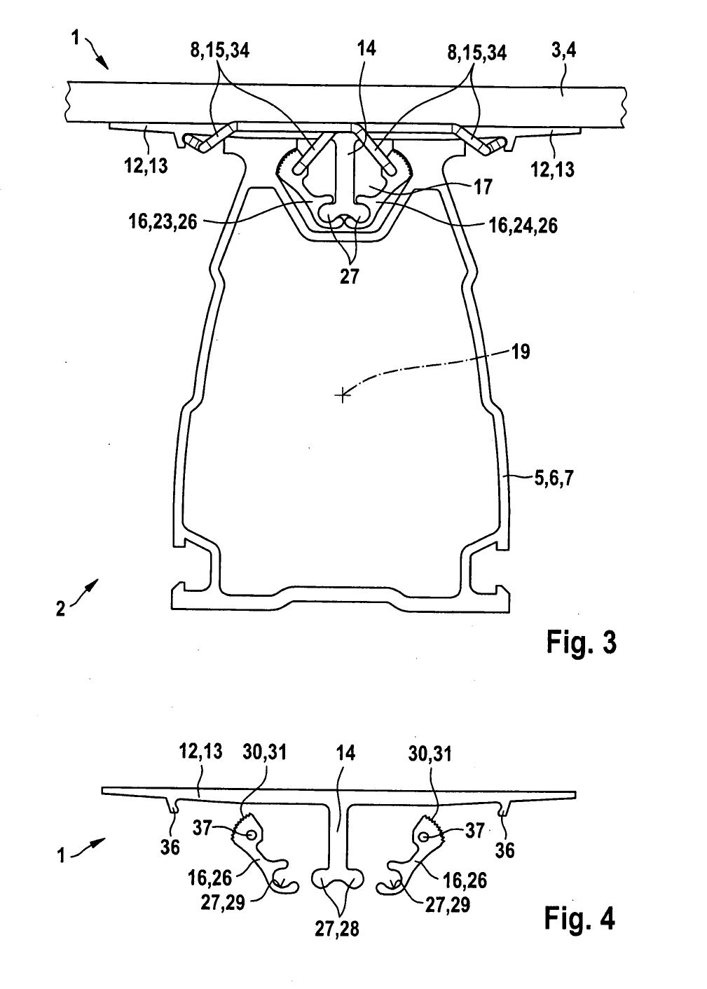

In the fields of structural engineering and construction, devices 1 are employed for fastening an add-on component 3 to a support part 5 (See FIG. 3). The add-on component 3 is, for instance, a photovoltaic module 4, a façade element or a line, and the support part 5 is a support rail 6 or a mounting rail 7. Therefore, the device 1 can be used to fasten the add-on component 3 to the support part 5 indirectly.

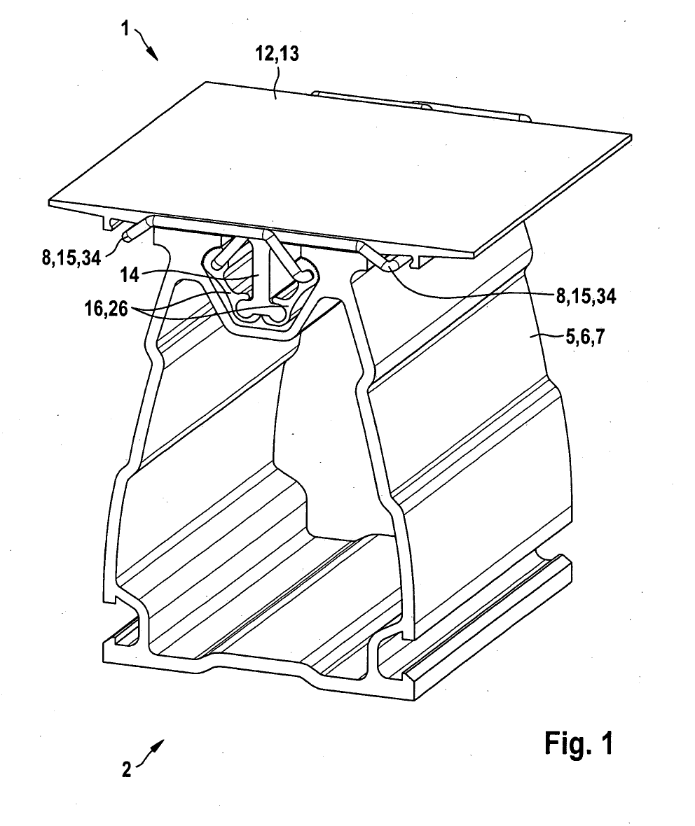

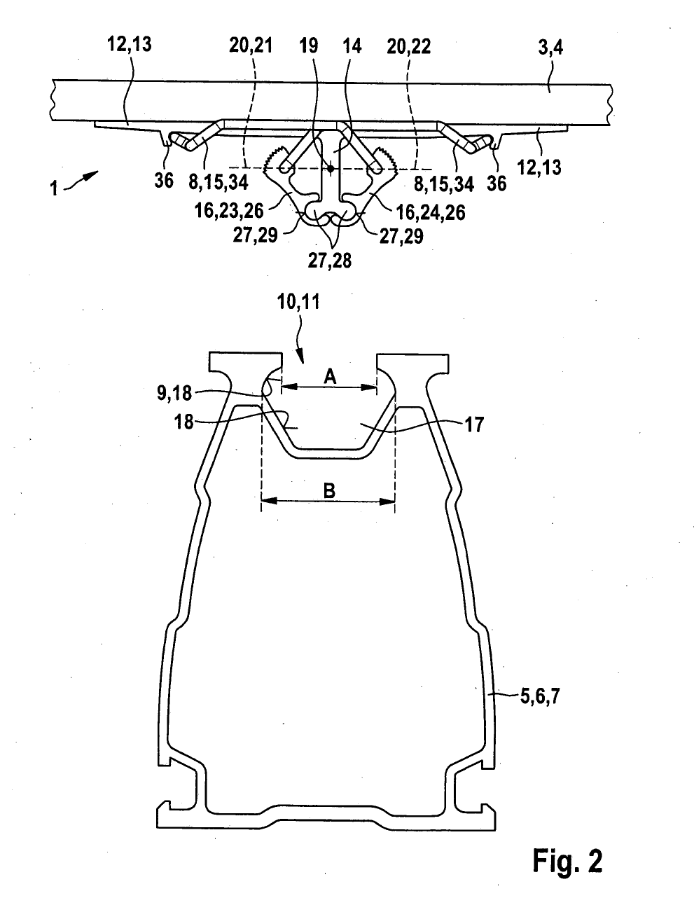

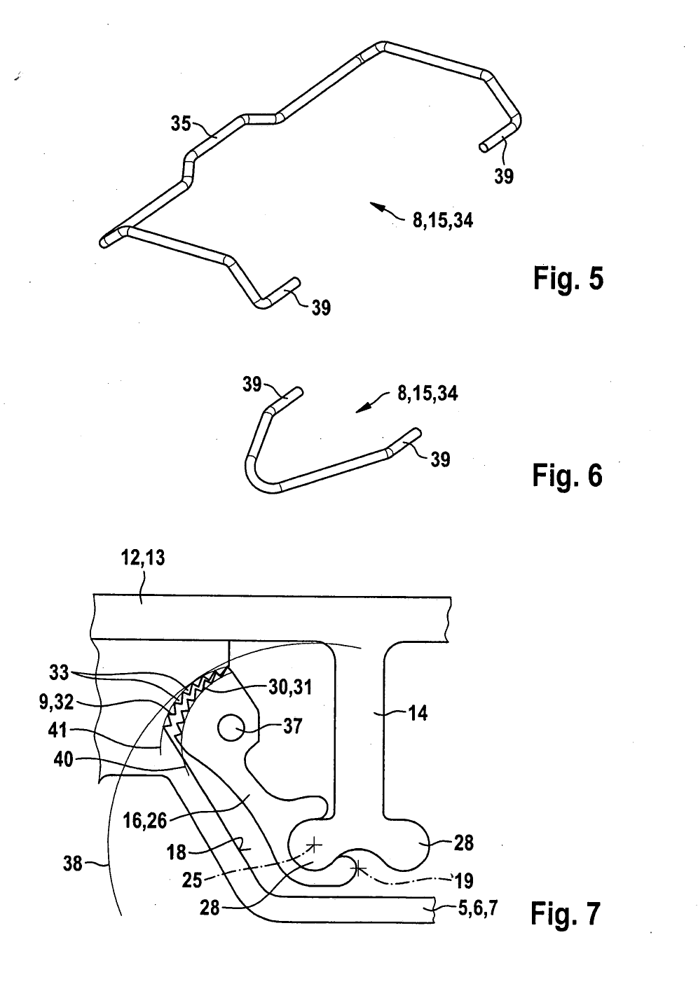

In this context, the device 1 comprises a carrier plate 13 as the means 12 for affixing the add-on component 3 to the device 1, and two movable holding elements 16 (FIGS. 1, 2 and 3). The carrier plate 13 is joined to the add-on component 3 as a single material connection, for instance, by means of adhesion or welding, or else by a positive connection, for example, with screws or rivets for purposes of creating a screwed or riveted connection. A web 14 (FIGS. 1 to 4) is present on the carrier plate 13 and configured in one piece with the carrier plate 13. The lower end of the web 14 is provided with two ball joints 28 (See FIG. 2 for example). A joint socket 29 of the holding element 16 is positively connected to each of the ball joints 28. Therefore, the ball joint 28 and the joint socket 29 together form an articulated joint 27, so that the holding element 16 can be pivoted as a chuck 26 around a rotational axis 25 (See FIG. 7). Here, the rotational axis 25 is perpendicular to the plane of projection of FIGS. 2, 3 and 7. Each of the two chucks 26 has a bore 37. In each of the two chucks 26, an end section 39 of each wire spring 34 as the spring 15 that forms an elastic element 34 is inserted into both ends of the bores 37 in a configuration of the wire spring 34 in the first embodiment according to FIG. 5 (see also FIG. 3). The wire springs 34 and the holding elements 16 are separate and detached parts. Consequently, the device 1 has two wire springs 34 whose end sections 39 are each inserted into both ends of the bores 37 for each chuck 26. An offset 35 (FIG. 5) of the wire spring 34 is connected by latching to a latching web 36 (FIGS. 1 and 3 for example) located on the carrier plate 13. The latching connection between the latching web 36 and the offset 35 of the wire spring 34 can be detached using a screwdriver, for example, and subsequently the wire spring 34 can be pulled out crosswise with respect to the longitudinal axis 19 of the rail once the end sections 39 have been removed from the bores 37. As a result, the chucks 26 can be moved out of the catching position so that the device 1 can be removed from the support rail 1 together with the add-on component 3. Consequently, there is a detachable connection between the device 1 and the support part 5. The carrier plate 13 has two latching webs 36 that are configured in one piece with the carrier plate 13. Each of the two chucks 26 is connected to a wire spring 34 so that the device 1 has two wire springs 34. The chucks 26 have a contact surface 30 that rests on the support rail 6, that is to say, on an edge 9 of the support rail 6 (FIGS. 1 and 3).

The mounting rail 7 has an opening 10 as a mounting opening, which is configured as a groove 11. The groove 11 extends with its larger extension in the direction of the longitudinal axis 19 of the rail. In this context, the inner contour 18 of the mounting rail 7 surrounds a hollow space 17 into which the opening 10 opens up. In an orientation parallel to the plane of projection of FIG. 2, the clear width A of the opening 10 is smaller than the clear width B of the hollow space 17 adjacent to the opening 10 (FIG. 2). Together with the device 1, the mounting rail 7, which is made of metal, for instance, aluminum or steel, or else made of plastic, forms a system 2 (FIG. 3) made of the same material for purposes of fastening the add-on component 3 to the support part 5.

In the embodiment of the device 1 shown in FIG. 2, two holding elements 16 are oriented opposite from a central longitudinal axis 19 of the rail. A plane 20 that intersects the longitudinal axis 19 of the rail and that is oriented parallel to a plane extending from the carrier plate 13 and that intersects the two holding elements 16 is divided by the longitudinal axis 19 of the rail into a first partial plane 21 and a second partial plane 22. Here, the first partial plane 21 intersects the first holding element 23 while the second partial plane 22 intersects the second holding element 24.

FIG. 2 shows a pre-mounted state in which the holding elements 16 are in a pre-mounted state. In the pre-mounted state, the elastic elements 8 are not pre-tensioned. The holding elements 16 are movable due to an elastic deformation of the wire spring 34.

In the pre-mounted state shown in FIG. 2, the distance between the ends of the holding elements 16 in a direction parallel to a plane formed by the carrier plate 13 and parallel to the plane of projection of FIG. 2 (distance direction) is greater than the clear width A of the opening 10 or mounting opening 10. When the device 1 is inserted and moved into the opening 10 and into the hollow space 17, the wedge-shaped orientation of the two holding elements 16 causes them to pivot around the rotational axis 25 (FIG. 7), so that the right-hand holding element 16 shown in FIG. 2 pivots in a counterclockwise rotational direction around the rotational axis 25, while the left-hand holding element 16 moves in a clockwise rotational direction around the rotational axis 25. As a result, the two holding elements 16 are moved from the pre-mounted position into an engagement position. In the engagement position (between the pre-mounted state and the catching position), the ends of the holding elements 16 rest on the support part 5 in the area of the clear width A of the opening 10. As a result, the distance between the ends of the holding elements 16 is smaller than in the pre-mounted position of the holding elements 16. When the device 1 is inserted further into the hollow space 17, the two chucks 26 can pivot opposite from the above-mentioned direction owing to the elastic pre-tensioning with the wire springs 34 as the elastic elements 8 due to the link to the articulated joint 27 on the web 14, so that the holding elements 16 move or snap into the catching position according to FIGS. 1 and 3. Therefore, the holding elements 16 are deformed back from the engagement position into the catching position according to FIGS. 1 and 3.

In the catching position of the holding elements 16 according to FIGS. 1 and 3, the holding elements 16 lie with their contact surfaces 30 on the edge 9 on the carrier rail 6, especially on the inner contour 18 of the support part 5 or on the mounting rail 7. As a result, a positive and/or non-positive connection is established between the device 1 and the support part 5. This is a connection with a wedge effect or eccentric effect. The contact surfaces 30 of the chucks 26 are configured so as to be curved essentially as contact-surface arcs 31 (FIG. 7). The edge 9 of the support rail 6 on which the chucks 26 rest is likewise configured so as to be curved essentially as edge arcs 32. The contact-surface arcs 31 and the edge arcs 32 are each provided with teeth 33. It is also possible for only the contact-surface arcs 31 or the edge arcs 32 to be provided with teeth 33, or else for the contact-surface arcs 31 and the edge arcs 32 not to be provided with teeth 33, in other words, to be configured smooth. For the chuck 7 shown in FIG. 7, the center point of the edge arc 32 is on the right-hand side and above the rotational axis 25 of the chuck 26. FIG. 7 shows an arc 38 with the rotational axis 25 as its center point 25, and an arc 41 on the edge arc 32. When the chuck 26 executes a clockwise pivoting movement around the rotational axis 25 as the clamping movement, the space between the chuck 26 and the edge 9 is reduced and vice versa. As a result, the connection between the device 1 and the support part 5 is self-tensioning due to the pre-tensioning that is exerted on the chucks 26 by means of the wire springs 34. The center point of the contact-surface arc 31 is likewise on the right-hand side and above the rotational axis 25 but further to the right and above with respect to the center point of the edge arc 32. Therefore, the contact-surface arc 31 of the chuck 26 approaches the edge 9 of the support rail 6 when the chuck 26 executes the above-mentioned pivoting movement. FIG. 7 also shows an arc 40 of the contact surface 30 of the chuck 26. This also applies analogously to the second chuck 26, which is not shown in FIG. 7.

When the device 1 is mounted onto the support part 5, the device 1 can first be placed onto the support rail 6. The distance between the holding elements 16 at the ends is greater than the clear width A of the opening 10. In order for the device 1 to be moved from the pre-mounted state according to FIG. 2 into the engagement position (between the pre-mounted state and catching position), due to the requisite elastic deformation of the wire springs 34, an additional force has to be applied downwards onto the device 1 in order to overcome the elastic force of the wire springs 34. The weight of the device 1 and of the add-on component is not sufficient for this purpose. As a result, before the projection 15 is pressed into the opening 10 in order to reach the catching position, it is possible to move the device 1 with the add-on component 3 on the mounting rail 7 in a direction perpendicular to the plane of projection of FIGS. 2 and 3. In this manner, for example, when photovoltaic modules 4 are mounted, they can be first oriented on the mounting rail 7, in other words, perpendicular to the plane of projection of FIGS. 2 and 3, and then, only once the final mounting position of the photovoltaic modules 4 has been reached, they can be permanently fastened to the mounting rail 7 by additionally pressing and applying a downward force, as shown in FIG. 2 where the device 1 is moved into the final mounted state as shown in FIGS. 1 and 3.

FIG. 6 shows a second embodiment of the wire spring 34. This wire spring 34 is not inserted with its end section 39 into the bore 37 on two opposite ends of the same chuck 26, but rather, the end sections 39 are each inserted into the bore 37 on two different chucks 26. Here, a first wire spring 34 is preferably arranged on two ends of the two chucks 26, and a second wire spring 34 (not shown here) is fastened to two opposite ends of the two chucks 26. With the two wire springs 34 in the second embodiment, the connection between the device 1 and the mounting rail 7 is permanent since the two wire springs 34 are arranged inside the hollow space 17 of the mounting rail 7 and are covered by the carrier plate 13, so that the two wire springs 34 are not accessible from the outside and thus cannot be removed or released.

On the whole, the device 1 according to the invention and the system 2 according to the invention entail considerable advantages. Add-on components 3 are fastened to support parts 5 in a structurally simple manner. This translates into cost savings during the production of the device 1 and of the system 2 and, owing to the fact that the holding elements 16 are not pre-tensioned in the pre-mounted state, no unintentional movement of the holding elements 16 occurs. Therefore, in the pre-mounted state, neither the device 1 nor the system 2 sustain any damage when the device 1 is subjected to small forces while in the pre-mounted state.

What is claimed is:

1. A device for fastening an add-on component to a support part, comprising:
at least one movable holding element that, when inserted into an opening of the support part due to contact between the at least one holding element and the support part, is movable into an engagement position so as to be inserted into the opening, and that, after insertion into the opening, is moveable into a catching position by a return movement of the at least one holding element so that the at least one holding element can catch behind at least one edge of the support part in order to create a positive connection between the at least one holding element and the support part; and
at least one means for affixing the add-on component to the device;
the at least one holding element movable from the engagement position into the catching position by at least one elastic element.

2. The device as recited in claim 1 wherein the at least one holding element and the at least one elastic element are separate parts.

3. The device as recited in claim 1 wherein the at least one holding element includes at least two holding elements, and/or, when the at least one holding element is in the catching position, the at least one holding element is arranged at least partially in a hollow space enclosed by the support part, and/or a non-positive connection is establishable between the at least one holding element and the support part.

4. The device as recited in claim 1 wherein the at least one means includes a carrier plate for affixing the device to the add-on component.

5. The device as recited in claim 1 wherein the at least one holding element is a chuck pivotable about a rotational axis.

6. The device as recited in claim 1 further comprising a web insertable into the opening and the at least one holding element is pivotably mounted on the web.

7. The device as recited in claim 6 wherein the web is formed on the carrier plate, and/or a plane formed by the web is arranged essentially perpendicular with respect to a plane formed by the carrier plate.

8. The device as recited in claim 1 wherein a contact surface of the at least one holding element on the support part is configured so as to be curved as a contact-surface arc.

9. The device as recited in claim 1 wherein the at least one edge of the support part catchable by the at least one support part is curved.

10. The device as recited in claim 1 wherein a center point of a contact-surface arc of the at least one holding element, and/or a center point of an edge arc of the at least one edge, and/or a rotational axis of the at least one holding element are oriented with respect to each other in such a way that, when the at least one holding element executes a clamping movement, a distance between the edge of the support part and a contact surface of the at least one holding element is reduced, and/or the at least one elastic element is configured as a spring.

11. A system for fastening an add-on component, comprising:
a support part; and
a device for fastening the add-on component to the support part, the device as recited in claim 1.

12. The system as recited in claim 11 wherein the support part is a support rail, and/or the opening is a groove and/or the opening opens up into a hollow space delimited by an inside contour of the support part, so that the at least one edge is formed by the inner contour of the support part so that the at least one edge can catch behind the at least one holding element.

13. The system as recited in claim 12 wherein, when the device is fastened to the support part, opposing first and second holding elements of the at least one holding element are oriented with respect to a plane that runs through a central longitudinal axis of the support rail in such a way that the plane runs through the two holding elements and the plane is divided by a central longitudinal axis of the rail into a first partial plane and a second partial plane, and the first holding element is intersected by the first partial plane while the second holding element is intersected by the second partial plane.

14. The system as recited in claim 13 wherein, before the first and second holding elements have been inserted into the opening, a distance between the ends of the first and second opposite holding elements in a direction of the distance is greater than a clear width of the opening in the direction of the distance, so that, when the first and second opposite holding elements are inserted, the holding elements can be moved due to the contact with the support part.

15. The system as recited in claim 11 wherein, when the device is fastened to the support part, the elastic element is pre-tensioned and consequently a pre-tensioning force can be exerted onto the at least one holding element, so that a clamping movement can be executed by the at least one holding element due to the pre-tensioning.

16. A device for fastening an add-on to a support having an opening, comprising:
at least one movable holder having an engagement position and a catching position, the holder in the engagement position contacting the support at the opening to permit insertion into the opening, and the holder, after insertion into the opening, being in the catching position where the at least one holder contacts behind at least one edge of the support to create a positive form-locking connection between the at least one holder and the support;
at least one connector for connecting the add-on to the holder; and
at least one spring for forcing the at least one holder from the engagement position into the catching position.

17. The device as recited in claim 1 wherein the positive form-locking connection is a toothed connection.

18. The device as recited in claim 16 wherein the connector is a carrier plate.

19. The device as recited in claim 18 wherein the carrier plate has a web extending into the opening.

20. A system for fastening an add-on comprising:
a support; and
the device as recited in claim 16.
